(19) United States
(12) Patent Application Publication
(10) Pub. No.: US 2022/0180291 A1
(43) Pub. Date: Jun. 9, 2022

(54) METHOD AND SYSTEM FOR WORKFLOW ASSIGNMENT

(71) Applicant: Hitachi, Ltd., Tokyo (JP)

(72) Inventors: Abeykoon Mudiyanselage Hunfuko Asanka ABEYKOON, Singapore (SG); Yoriko KAZAMA, Singapore (SG)

(73) Assignee: Hitachi, Ltd., Tokyo (JP)

(21) Appl. No.: 17/599,021

(22) PCT Filed: Apr. 2, 2019
(86) PCT No.: PCT/SG2019/050190

§ 371 Date: Sep. 28, 2021

(51) Int. Cl. G06Q 10/06

(52) U.S. Cl. CPC G06Q 10/063112; G06Q 10/0633

(57) ABSTRACT

There is provided a method of workflow assignment, including: identifying an actionable event; determining a plurality of tasks for the actionable event; determining, for each of the plurality of tasks, one or more task parameters related to the task; and generating, for the actionable event, a workflow for each of one or more individuals to perform at least one of the plurality of tasks based on the one or more task parameters. There is also provided a corresponding system for workflow assignment.

### TECHNICAL FIELD

The present invention generally relates to a method of workflow assignment, and a system thereof, and more particularly, in relation to management of human resources.

### BACKGROUND

Managing and maintaining an enterprise or a certain space (e.g., building, shopping mall, city, critical infrastructure, and so on), including associated services, are becoming extremely complex. For example, managing and maintaining such a space may include emergency response, security, energy and facility related operations. Due to urbanization, business expansions and increased demands for services or service quality, complex monitoring, command, control, maintenance and response needs have raised. Various types of human resources required to deal with these circumstances arise from complex requirements and needs while human resources are limited and costly. For example, human resources may be involved in performing tasks (e.g., services, actions, response or the like) to mitigate or reduce certain effects, risks and so on. Therefore, efficient utilization of human resources has been a major challenge in modern human resource management, such as monitoring, command, control, maintenance and/or ground operations and related systems/environments.

For example, various conventional techniques for managing human resources (e.g., including workflow assignment) use static workflows, which may not be able to adapt to various challenges that may arise, resulting in significant inefficiencies in the management of human resources.

A need therefore exists to provide a method of workflow assignment and a system thereof, that seek to overcome, or at least ameliorate, one or more of the deficiencies in conventional techniques for managing human resources, such as but not limited to, for improving or enhancing efficiencies in management of human resources. It is against this background that the present invention has been developed.

### SUMMARY

According to a first aspect of the present invention, there is provided a method of workflow assignment, using at least one processor, the method comprising: identifying an actionable event; determining a plurality of tasks for the actionable event; determining, for each of the plurality of tasks, one or more task parameters related to the task; and generating, for the actionable event, a workflow for each of one or more individuals to perform at least one of the plurality of tasks based on the one or more task parameters.

According to a second aspect of the present invention, there is provided a system for workflow assignment, the system comprising: a memory; and at least one processor communicatively coupled to the memory and configured to: identify an actionable event; determine a plurality of tasks for the actionable event; determine, for each of the plurality of tasks, one or more task parameters related to the task; and generate, for the actionable event, a workflow for each of one or more individuals to perform at least one of the plurality of tasks based on the one or more task parameters.

A computer program product, embodied in one or more non-transitory computer-readable storage mediums, comprising instructions executable by at least one processor to perform a method of workflow assignment comprising: identifying an actionable event; determining a plurality of tasks for the actionable event; determining, for each of the plurality of tasks, one or more task parameters related to the task; and generating, for the actionable event, a workflow for each of one or more individuals to perform at least one of the plurality of tasks based on the one or more task parameters.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a flow diagram illustrating a method of workflow assignment, according to various embodiments of the present invention;

FIG. 2 depicts a schematic block diagram of a system for workflow assignment, according to various embodiments of the present invention;

FIG. 3 depicts an example computer system, which the system as described with respect to FIG. 2 may be embodied in, by way of an example only;

FIG. 4 depicts a table identifying a number of challenges encountered in relation to the efficient human resources utilization problem according to various example embodiments of the present invention;

FIG. 5 depicts a flow diagram illustrating an exemplary method of workflow assignment according to various example embodiments of the present invention;

FIG. 6 depicts a schematic drawing of an exemplary system, along with exemplary operational flow, for workflow assignment according to various example embodiments of the present invention;

FIG. 7 depicts a schematic drawing of the exemplary system of FIG. 6, with operational flow of the workflow engine shown in greater details, according to various example embodiments of the present invention;

FIG. 8 depicts a schematic drawing illustrating an exemplary operational flow of the exemplary system of FIG. 6, with respect to the workflow generation/modification module of the workflow engine, according to various example embodiments of the present invention; and

FIG. 9 depicts a schematic drawing illustrating a high-level visualization of a method of workflow assignment to a plurality of individuals, according to various example embodiments of the present invention.

### DETAILED DESCRIPTION

Various embodiments of the present invention provide a method of workflow assignment and a system thereof, and more particularly, in relation to management of human resources.

As described in the background, various conventional techniques for managing human resources (e.g., including workflow assignment) suffer from significant inefficiencies. Therefore, various embodiments of the present invention provide a method of workflow assignment and a system thereof, that seek to overcome, or at least ameliorate, one or more of the deficiencies in conventional techniques for managing human resources, such as but not limited to, for improving or enhancing efficiencies in management of human resources.

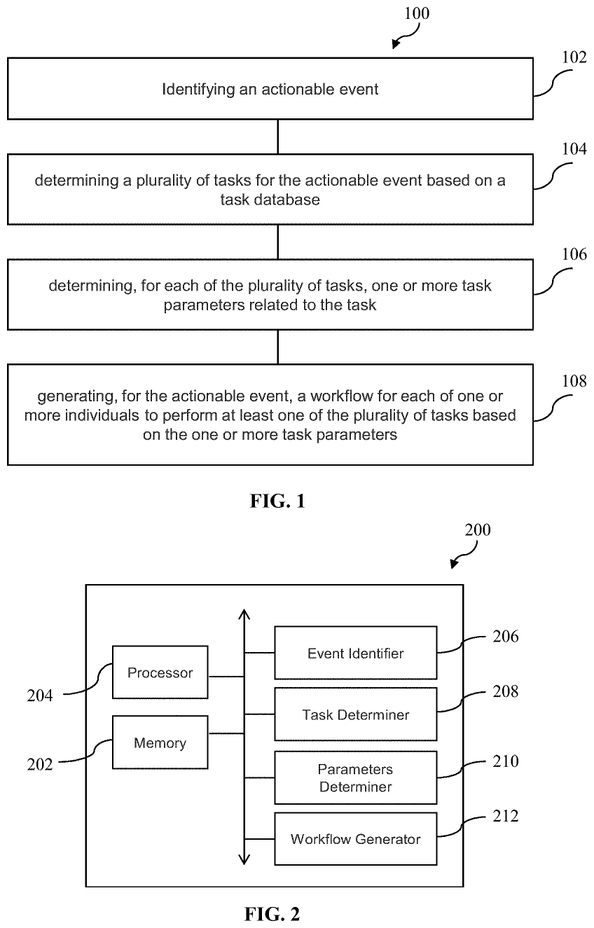

FIG. 1 depicts a flow diagram illustrating a method 100 of workflow assignment using at least one processor, according to various embodiments of the present invention. The method 100 comprises: identifying (at 102) an actionable event; determining (at 104) a plurality of tasks for the actionable event; determining (at 106), for each of the plurality of tasks, one or more task parameters related to the task; and generating (at 108), for the actionable event, a workflow for each of one or more individuals to perform at least one of the plurality of tasks based on the one or more task parameters.

In various embodiments, the method 100 further comprises determining, for each of the plurality of tasks, one or more human resource parameters related to the task. In this regard, the above-mentioned generating the workflow is further based on the one or more human resource parameters.

In various embodiments, the above-mentioned generating the workflow comprises optimizing the workflow for each of the one or more individuals based on the one or more task parameters, the one or more human resource parameters and one or more predetermined conditions.

In various embodiments, the one or more predetermined conditions may be one or more performance indicators (e.g., key performance indicators (KPIs) and/or predetermined constraints).

In various embodiments, the workflow for an individual may define an order of tasks (e.g., including sub-tasks) to be performed by the individual. In various embodiments, the workflow may further define or indicate a time for performing each task. In various embodiments, the workflow is generated to produce a workflow data and may be transmitted (e.g., via any wireless or wired communication protocol known in the art) to a communication device (e.g., a mobile communication device) associated with the individual for the individual to perform the task(s) set out in the workflow.

In relation to 102, for example, the actionable event may be identified based on any form of monitoring or surveillance. By way of an example only and without limitation, an actionable event in relation to an elevator breakdown may be identified based on an elevator breakdown signal received from an elevator monitoring system. As another example, an actionable event in relation to a vehicle accident may be identified based on a vehicle accident signal received from a traffic surveillance system, which may be configured to detect the vehicle accident based on video analysis. Various monitoring or surveillance techniques and systems exist and are known in the art, and thus need to be described herein for clarity and conciseness.

In various embodiments, the method of workflow assignment may be implemented by an enterprise (e.g., an organization or a company) for managing its human resources and human resources accessible by the enterprise (e.g., via affiliation or in cooperation with another enterprise). Accordingly, in various embodiments, an individual or the like as described herein may be selected from such human resources.

In various embodiments, the method further comprises: determining a ranking of the plurality of tasks to obtain a tasks ranking; and determining, for each of the plurality of tasks, a ranking of a plurality of individuals with respect to the task to obtain an individuals ranking for the task.

In various embodiments, the one or more human resource parameters include a current location and a current availability of the individual, and the above-mentioned ranking of the plurality of individuals with respect to the task is determined based on the current availability and the current location of each of the plurality of individuals.

In various embodiments, the one or more human resource parameters further include a performance of each of the plurality of individuals with respect to the task, and the above-mentioned ranking of the plurality of individuals with respect to the task is determined further based on the performance of each of the plurality of individuals with respect to the task.

In various embodiments, the one or more task parameters are selected from a group consisting of a location, a priority, a type, a frequency, a time, a cost and one or more required assets associated with the task, and the above-mentioned ranking of the plurality of tasks is determined based on the one or more task parameters associated with each of the plurality of tasks.

In various embodiments, the method 100 further comprises determining an emergency rating for the plurality of tasks, wherein said ranking of the plurality of tasks is determined further based on the emergency rating.

In various embodiments, the one or more task parameters further comprises an environment condition relating to the task.

In various embodiments, the above-mentioned optimizing the workflow is further based on the individuals ranking and the tasks ranking.

In various embodiments, the method further comprises logging workflow executions to produce a workflow execution log database, wherein at least one of the one or more task parameters and the one or more human resource is determined based on the workflow execution log database.

In various embodiments, the at least one of the one or more task parameters and the one or more human resource is determined using on a machine learning model based on the workflow execution log database.

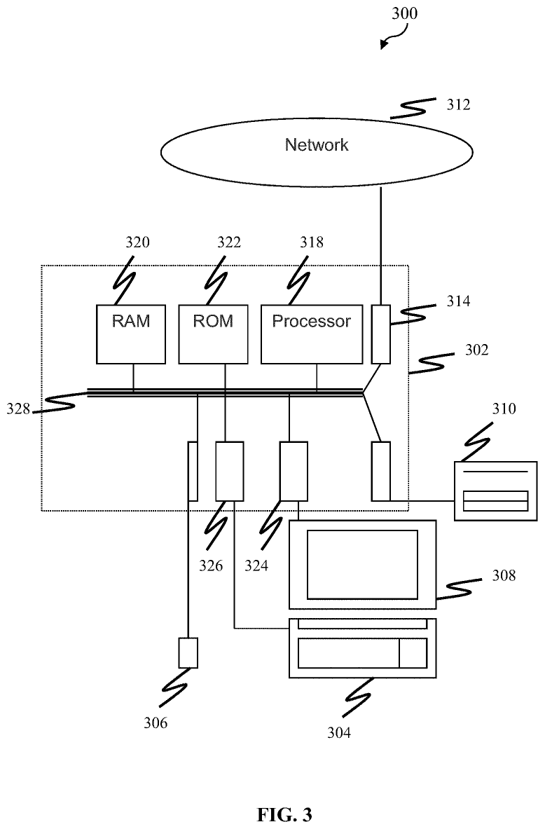

FIG. 2 depicts a schematic block diagram of a system 200 for workflow assignment, according to various embodiments of the present invention, such as corresponding to the method 100 of workflow assignment as described hereinbefore with reference to FIG. 1 according to various embodiments of the present invention. The system 200 comprises a memory 202, and at least one processor 204 communicatively coupled to the memory 202 and configured to: identify an actionable event; determine a plurality of tasks for the actionable event; determine, for each of the plurality of tasks, one or more task parameters related to the task; and generate, for the actionable event, a workflow for each of one or more individuals to perform at least one of the plurality of tasks based on the one or more task parameters. It will be appreciated to a person skilled in the art that the system 200 may also be embodied as a device or an apparatus.

It will be appreciated by a person skilled in the art that the at least one processor 204 may be configured to perform the required functions or operations through set(s) of instructions (e.g., software modules) executable by the at least one processor 204 to perform the required functions or operations. Accordingly, as shown in FIG. 2, the system 200 may further comprise an event identifier (or an event identifying module or circuit) 206 configured to perform the above-mentioned identifying (at 102) an actionable event; a task determiner (or a task determining module or circuit) 208 configured to perform the above-mentioned determining (at 104) a plurality of tasks for the actionable event; a parameters determiner (or a parameters determining module or circuit) 210 configured to perform the above-mentioned determining (at 106), for each of the plurality of tasks, one or more task parameters related to the task; and a workflow generator 212 configured to perform the above-mentioned generating (at 108), for the actionable event, a workflow for each of one or more individuals to perform at least one of the plurality of tasks based on the one or more task parameters.

It will be appreciated by a person skilled in the art that the above-mentioned modules are not necessarily separate modules, and one or more modules may be realized by or implemented as one functional module (e.g., a circuit or a software program) as desired or as appropriate without deviating from the scope of the present invention. For example, two or more of the event identifier 206, the task determiner 208, the parameters determiner 210 and a workflow generator 212 may be realized (e.g., compiled together) as one executable software program (e.g., software application or simply referred to as an “app”), which for example may be stored in the memory 202 and executable by the at least one processor 204 to perform the functions/operations as described herein according to various embodiments.

In various embodiments, the system 200 corresponds to the method 100 as described hereinbefore with reference to FIG. 1, therefore, various functions or operations configured to be performed by the least one processor 204 may correspond to various steps of the method 100 described hereinbefore according to various embodiments, and thus need not be repeated with respect to the system 200 for clarity and conciseness. In other words, various embodiments described herein in context of the methods are analogously valid for the respective systems (e.g., which may also be embodied as devices), and vice versa.

For example, in various embodiments, the memory 202 may have stored therein the event identifier 206, the task determiner 208, the parameters determiner 210 and/or a workflow generator 212, which respectively correspond to various steps of the method 100 as described hereinbefore according to various embodiments, which are executable by the at least one processor 204 to perform the corresponding functions/operations as described herein.

A computing system, a controller, a microcontroller or any other system providing a processing capability may be provided according to various embodiments in the present disclosure. Such a system may be taken to include one or more processors and one or more computer-readable storage mediums. For example, the system 200 described hereinbefore may include a processor (or controller) 204 and a computer-readable storage medium (or memory) 202 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of the respective functions which will be described in more detail below may also be understood as a “circuit” in accordance with various alternative embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “extracting”, “forming”, “generating”, “analyzing”, “chunking”, “identifying”, “labelling”, “linking”, “configuring”, “processing”, “performing” or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a system (e.g., which may also be embodied as a device or an apparatus) for performing the operations/functions of the methods described herein. Such a system may be specially constructed for the required purposes, or may comprise a general purpose computer or other device selectively activated or reconfigured by a computer program stored in the computer. The algorithms presented herein are not inherently related to any particular computer or other apparatus. Various general-purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that the individual steps of the methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention. It will be appreciated by a person skilled in the art that various modules described herein (e.g., the component extractor 206 and/or the data graph generator 208) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements the steps of the methods described herein.

In various embodiments, there is provided a computer program product, embodied in one or more computer-readable storage mediums (non-transitory computer-readable storage medium), comprising instructions (e.g., the event identifier 206, the task determiner 208, the parameters determiner 210 and/or a workflow generator 212) executable by one or more computer processors to perform a method 100 of workflow assignment as described hereinbefore with reference to FIG. 1. Accordingly, various computer programs or modules described herein may be stored in a computer program product receivable by a system therein, such as the system 200 as shown in FIG. 2, for execution by at least one processor 204 of the system 200 to perform the required or desired functions.

The software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

In various embodiments, the system 200 may be realized by any computer system (e.g., portable or desktop computer system, such as tablet computers, laptop computers, mobile communications devices (e.g., smart phones), and so on) including at least one processor and a memory, such as a computer system 300 as schematically shown in FIG. 3 as an example only and without limitation. Various methods/steps or functional modules (e.g., the event identifier 206, the task determiner 208, the parameters determiner 210 and/or a workflow generator 212) may be implemented as software, such as a computer program being executed within the computer system 300, and instructing the computer system 300 (in particular, one or more processors therein) to conduct the methods/functions of various embodiments described herein. The computer system 300 may comprise a computer module 302, input modules, such as a keyboard 304 and a mouse 306, and a plurality of output devices such as a display 308, and a printer 310. The computer module 302 may be connected to a computer network 312 via a suitable transceiver device 314, to enable access to e.g., the Internet or other network systems such as Local Area Network (LAN) or Wide Area Network (WAN). The computer module 302 in the example may include a processor 318 for executing various instructions, a Random Access Memory (RAM) 320 and a Read Only Memory (ROM) 322. The computer module 302 may also include a number of Input/Output (I/O) interfaces, for example I/O interface 324 to the display 308, and I/O interface 326 to the keyboard 304. The components of the computer module 302 typically communicate via an interconnected bus 328 and in a manner known to the person skilled in the relevant art.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

As described in the background, managing and maintaining an enterprise or a certain space (e.g., building, shopping mall, city, critical infrastructure, and so on), including associated services, are becoming extremely complex. For example, managing and maintaining such a space may include emergency response, security, energy and facility related operations. Due to urbanization, business expansions and increased demands for services or service quality; complex monitoring, command, control, maintenance and response needs have raised. Various types of human resources required to deal with these circumstances arise from complex requirements and needs while human resources are limited and costly. For example, human resources may be involved in performing tasks (e.g., services, actions, response or alike) to mitigate or reduce certain effects, risks and so on. Therefore, efficient utilization of human resources has been a major challenge in modern human resource management, such as monitoring, command, control, maintenance and/or ground operations and related systems/environments

For example, human resources required for modern complex monitoring, command, control, and maintenance needs may be divided in to two main groups, namely, operations center staff and ground staff. These two types of human resources may involve in two types of operations, namely, emergency operations and non-emergency operations. Furthermore, the above-mentioned two main groups of human resources may further be categorized based on operations type that they are engaging with. In this regard, according to various example embodiments, efficient utilization of human resources take into account optimal assignment, conduct of various situations that may arise and/or operations that may be defined based on situation.

For example, in modern complex spaces such as cities, critical infrastructures, shopping malls, and so on, there may be multiple kinds of incidents that may take place on different quantities based on nature, size and/or area of the space. When such a space become larger and complex, increasing number of human resources may be required to conduct ground operations as well as operations center tasks. However, cost of human resources may affect business profit, maintenance and operating cost, quality, and so on. Accordingly, various example embodiments seek to minimize and/or optimize human resources. On the other hand, various example embodiments note that having a minimal amount human resources may not be adequate. For example, various example embodiments seek to ensure service quality from minimal ground officers and/or satisfying certain service key performance indicators (KPIs), such as optimizing response time to certain event(s), guaranteeing completion time for certain repair task(s) and so on.

Thus, various example embodiments seek to provide efficient human resources utilization to provide services meeting certain quality level while maintaining operating human resources cost at a minimal or while utilizing existing minimal human resources to address complex situations, tasks, actions, response or the like.

Accordingly, various example embodiments seek to solve efficient human resource utilization (e.g., even in complex environments) while optimizing the number of human resources required (e.g., minimum number of human resources) and furthermore, assigning a workflow to each individual (or a group of individuals) to meet operational KPIs based on various human resource parameters (e.g., performance (e.g., skill, experience and relevance) and location) of each individual (e.g., human resource) with respect to various events that may take place in different locations/time and with different priorities. Furthermore, various example embodiments seek to resolve practical situations or conditions that may arise with human resources, such as individual expertise (e.g., performance), absence or presence (e.g., availability) at a certain time as well as situations on ground where different kinds of situations, incidents, events that may take place with different level or priorities in different locations.

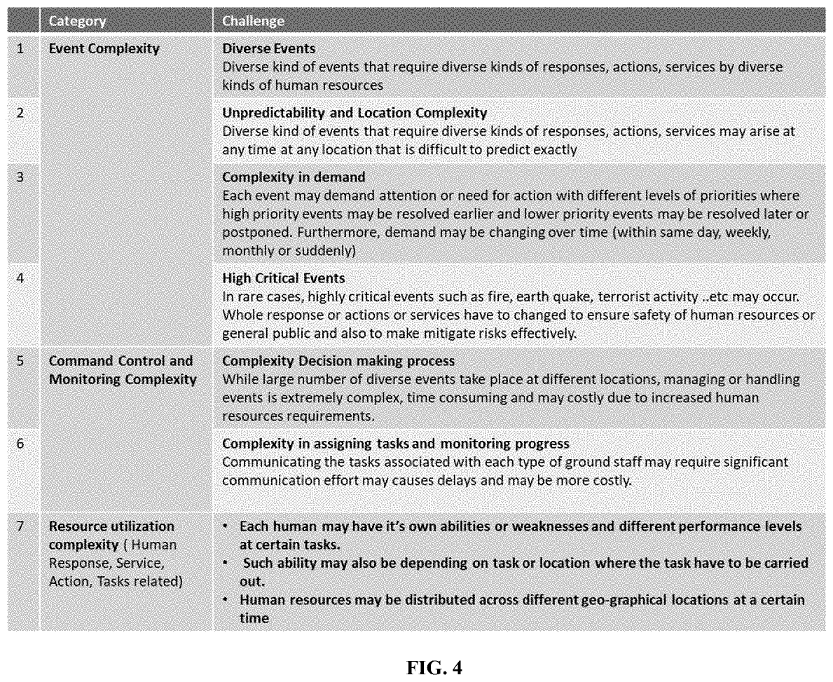

Various example embodiments identify a number of main challenges encountered when solving efficient human resources utilization problem, such as in large and complex environments, and they are summarized in a table in FIG. 4.

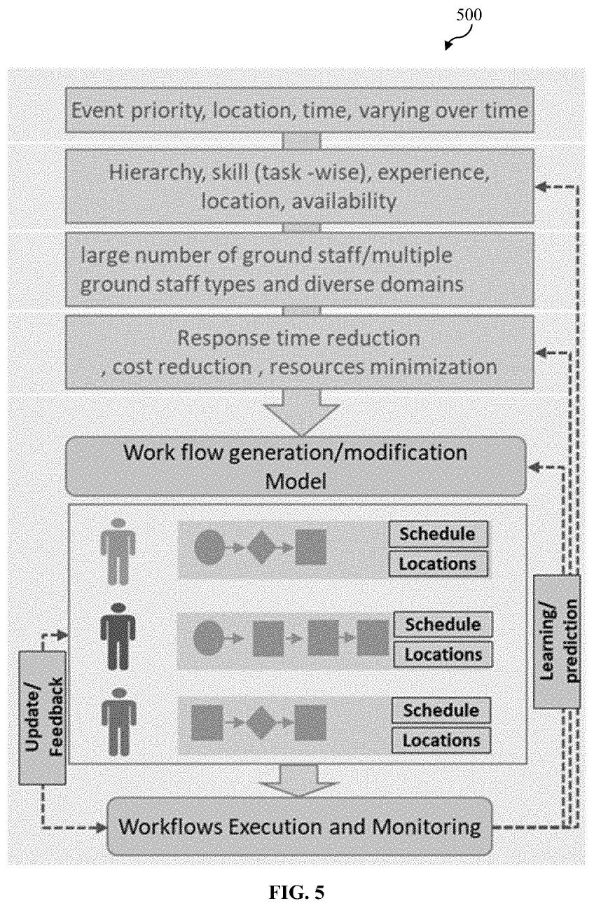

In order to address various challenges and issues of conventional techniques, various example embodiments provide systems and methods that automatically generate or modify individual human centric workflows that are dynamic, in stark contrast with static event or tasks-based workflows in various conventional techniques, such as described in the background. For example, in various conventional techniques, the static workflows are less flexible and are not able to efficiently deal with event, environment and/or human related complexities, such as the challenges summarized in FIG. 4. For example, according to various embodiments, the human centric workflow generation or modification is automatically conducted based on events complexities (e.g., location, priority, time, type of event, and so on) (e.g., corresponding to “task parameters” as described hereinbefore) and also based on human related conditions (e.g., skills level, experience, performance, and so on) (e.g., corresponding to “human resource parameters” as described hereinbefore). Furthermore, according to various example embodiments, human or event related complexities (e.g., task parameters and human resource parameters) are determined (e.g., predicted) based on workflow execution monitoring, and thus, are adaptable to changes in environment conditions over time or suddenly in highly critical situations (e.g., fire, earth quake and so on). Various example embodiments further enable periodic updating by ground staff based on automatically generated workflows to monitor progress or update status or to provide situation awareness on ground or operations centers. In this regard, FIG. 5 depicts a flow diagram illustrating a method 500 of workflow assignment according to various example embodiments, which advantageously address the efficient human resource utilization problem and challenges summarized in FIG. 4.

Thus, according to various example embodiments, systems and methods are provided that enable or facilitate:
automatically generate or modify individual human centric workflows instead of static event or tasks-based workflows based on varying human, event and/or ground conditions;
managing various kinds operations efficiently and automatically while allocating necessary human resources based on dynamic workflows to obtain optimal service/operational KPIs (e.g., response time, risk mitigation and so on);
minimization of human resources required to conduct monitoring operations, command operations, control operations, maintenance response operations or the like based on predictions and based on dynamic workflows; and
support for auditing review requirements, and so on.

Accordingly, various example embodiments provide system(s) and method(s) that initiate plurality of workflows depend on the type of situation that arises (e.g., including emergency and non-emergency situations) and make the workflows dynamic. For example, workflows may be automatically generated (including existing workflows being modified) based on existing human resources, their skill/experience parameters (e.g., corresponding to “human resource parameters” as described hereinbefore) and situation parameters (e.g., corresponding to “task parameters” as described hereinbefore), such as location, event priority, time, and so on, to make efficient utilization of human resources. In various example embodiments, task parameters and human resource parameters (e.g., performance, for example, based on skill and experience) may be learned using a machine learning model. The machine learning model may be based on any existing machine learning model or technique known in the art, and thus need to be described in detail herein for clarity and conciseness.

Various example embodiments are directed to techniques and arrangements which may be used in utilization of human resources for various tasks (e.g., services, actions or the like), including emergency and non-emergency event response contexts. For example, various example embodiments may be applied to in surveillance monitoring, energy management, facility management and so on, where multiple kinds of tasks may be geographically distributed and may arise anytime and randomly based on situations arise from various kinds of events. Furthermore, these tasks may be related to activities of different domains such as public safety and security, transportation, logistics management, retail and hospitality, smart cities and so on. Furthermore, various example embodiments may be used in command, control, monitoring and maintenance related system that is applied in diverse domains.

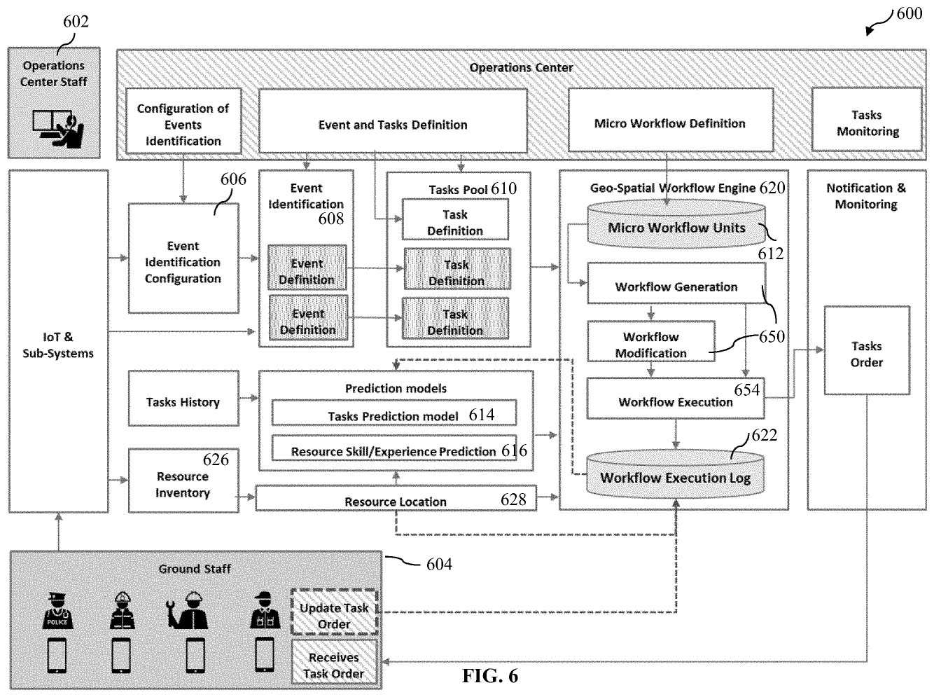

FIG. 6 depicts a schematic drawing of an exemplary system 600 for workflow assignment according to various example embodiments of the present invention. As shown in FIG. 6, the exemplary system may be connected to (e.g., capable of communicating with) two kind of human resources, namely, operations center staff 602 and ground staff 604 of different kinds who have different expertise and different responsibilities. For example, a plurality of operations center staff may use operations center applications that allows configuration, command, control, monitoring, auditing tasks or the like that oversee on ground conditions/tasks. There may be one or more operations centers operating according to various example embodiments. Furthermore, different kinds of ground staff on ground may be provided with portable mobile devices that is connected to (e.g., capable of communicating with) the system 600 via wireless communications to, for example, receive tasks orders or update tasks orders to conduct related functionalities, such as communication, situation awareness and so on.

In various example embodiments, the system 600 may be connected to various monitoring/surveillance systems or sub-systems (not shown), such as feeds (e.g., weather information, traffic information and so on), sensors or Internet of Things (IoT) platforms, configured to provide data, information, alerts, incidents or the like in relation to a space or environment being monitored. The system 600 may further comprise an event identification configuration module 606 where various conditions, rules and/or models may be applied on contents or data captured by the monitoring systems for identifying an actionable event. The event identification configuration module 606 may be configured to derive events or the like (e.g., incidents) which requires a certain response. Such response required may involve a plurality of ground staff of different kinds to perform certain tasks (e.g., actions or services), for example, in a specific or non-specific order to mitigate effects, risks or damages from the event. Based on the event identification configuration module 606, the event identification module 608 may detect different kinds of incidents/events/alerts or alike to identify actionable event(s).

In various example embodiments, each event (e.g., incident, accident, alert or the like) may be compared with a corresponding event definition and all tasks associated with the event (e.g., as defined by the corresponding event definition) may then be directed to a tasks pool 610. For example, as shown in FIG. 6, the tasks pool 610 may include a tasks definition for each event identified, and the associated event definition.

In various example embodiments, each task definition may be defined by micro workflow units 612 that may define whole or part of a certain task. By way of an example, breakdown of an elevator may be identified via the event identification configuration module 606 and this event may be associated with a certain set of tasks. For example, repairing the elevator may be associated with an on-site fixing task that may further include several inspection tasks. These tasks or micro tasks of different scale may be defined or enforced via micro workflow units defined via micro workflow definitions. Thus, the tasks pool 610 may include micro workflow units initialized in relation to each event response as necessary.

In addition, the system 600 may further include two kinds of prediction models, namely, a tasks prediction model 614 and a resource prediction model 616. The tasks prediction model 614 may be configured to predict task parameters (e.g., time, cost, resources and so on) required for each micro workflow unit or for a part of a single micro workflow unit or for a complete task or for a full event response related task. The resource prediction model 616 may be configured to predict human resource parameters (e.g., individual ground staff members' performance) for each micro workflow unit or for a part of a single micro workflow unit or for a complete task or for a full event response related task based on the individual's relevant category of response/service provided. In various example embodiments, these models may be learned by utilizing workflow execution data stored in workflow execution log database 622 in the geo-spatial workflow engine 620.

Furthermore, the system 600 may further include a resource inventory 626 that keep track of human resources and assets that can be accessible or covered as part of the system 600. For example, the resource inventory 626 may maintain human resources details of all individuals (e.g., employed by the organization) and may enable checking of the current availability of the individuals, for example, via each individual login status. In addition, a resource location module 628 may be provided for tracking location of an individual or an asset, for example, via location metadata provided by an associated mobile device being carried by the individual or the asset.

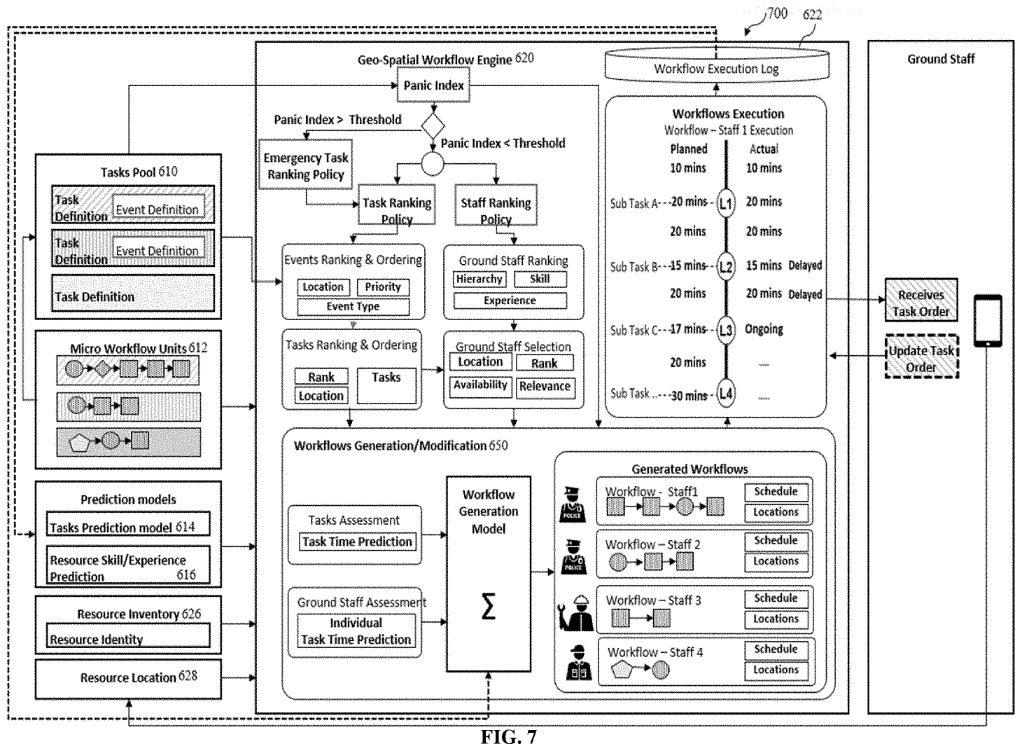

The system 600 may further include a geo-spatial workflow engine (GWE) 620. In various example embodiments, the GWE 620 may be configured to perform or execute an example operational flow 700 as shown in FIG. 7, which may result in an optimal allocation, scheduling and task ordering of human resources for various kinds of tasks that may be included in task pool 610.

In various example embodiments, the GWE 620 may be configured to perform the task ordering in real-time mode or batch processing mode or as a mix of real-time and batch processing based on the priority of an event. In various example embodiments, the GWE 620 may be configured to determine an emergency rating (e.g., calculate a panic index) periodically to identify highly critical situations, such as fire, terrorist activity or the like. This panic index may be manually activated or may be automatically calculated based on tasks pool or events identified. The panic index may be used to identify the critical situations. For example, if the panic index is below a certain threshold, the GWE 620 may be configured to conduct tasks ordering in a usual or normal manner. On the other hand, if panic index is above a certain threshold, the GWE 620 may be configured to modify all the tasks orders provided to handle the critical situation.

In various example embodiments, the GWE 620 may include one or more tasks ranking policies based on related task parameters (e.g., location, priority, event type, frequency, time, cost, resource required and so on), where tasks ranking policies may be different according to various example embodiments. In certain examples, the tasks ranking polices may be defined as a mathematical model, equation or the like to generate a rank of a certain or all set of items in tasks pool at a time. Following the tasks ordering policy, the GWE 620 may rank and order events and associated tasks based on the related task parameters.

In various example embodiments, similar to the tasks ranking policy, the GWE 620 may include one or more staff ranking policies (e.g., one or more based on kinds of human resources available for performing different type of response/services such as fire, security, facility management, maintenance, cleaning, and so on). For example, ranking may be particularly applied to ground staff based on their hierarchy, skill, experience. Furthermore, the ground staff may further be ranked based on their current availability (e.g., performing another task or not), current location, rank in previous step, relevance to tasks available (e.g., maintenance staff may not be allocated for security related tasks).

In various example embodiments, the GWE 620 may further include a workflow generation or modification (WGM) module 650 configured to generate a workflow (e.g., including modifying a workflow) based on the event identified and task rankings, ground staff rankings, and various selected data collected from external sources, such as traffic information

In various example embodiments, the WGM 650 may identify the high priority to low priority tasks in order with associated information such as location, predicted time for each task, type of human resource required and quantities required (e.g., events ranking and ordering followed by tasks ranking and ordering) along with highly skilled to low skilled ground staff details for each tasks type with their current location (ground staff ranking and selection). With such information, the WGM 650 may also utilize the prediction models 614, 616 as described hereinbefore to predict and evaluate: (1) the time required for each ground staff to conduct relevant or associated tasks in current tasks pool based on resource skill/experience prediction model 616, and (2) an average time, resources required for each task in general based on task prediction model 614.

After deriving the above-mentioned information, in various example embodiments, the WGM 650 may run mathematical models that optimize certain KPIs such as response time, task cost, human resource cost, priority indexes and so on.

Based on the mathematical models, the WGM 650 may generate optimized workflows dynamically that optimize the KPIs of interest according to various example embodiments as described hereinbefore. The WGM 650 may then assign a unique workflow to each individual staff or a certain group of individual staff. For example, two police officer with different skills level and experience may be allocated two different kinds of workflows for a given day. By way of an example only and without limitation, a first officer may be assigned with 4 tasks to be carried out in 3 locations while a second officer may be assigned with 2 tasks to be carried out in 2 locations for a given day/shift. In various example embodiments, each workflow generated for an individual staff may further include predicted schedule and locations that satisfies certain KPIs or quality constraints specified in the WGM 650.

In various example embodiments, the GWE 620 may further include a workflow execution module 654 configured to store logging status of each workflow generated for an individual staff that may include predicted schedule and locations. For example, ground staff location may be periodically checked by workflow execution via the resource location module 628, and may also keep track of tasks progress, delays or status for each workflow generated for an individual. Ground staff may further update the status of each tasks of his/her workflow via a mobile device provided. All these information may further be stored in the workflow execution log 622.

In various example embodiments, any anomalies in individual workflows may be informed or alerted to operations center for necessary actions.

In various example embodiments, the workflow execution log 622 may be further utilized by prediction models (e.g., the tasks prediction model 614 and the resource skill/experience prediction model 616) and workflow generation model. These models may be reinforced to update or adjust hyper parameters/configurations based on the workflow execution log 622. For example, if there is a difference in actual execution and predicted execution of a certain task, individual skill/performance or a workflow prediction, such a difference may be used as a penalty in the above-mentioned models to make necessary changes by itself (e.g., update or adjust hyper parameters/configurations). This reinforcement may lead to more dynamically adapting predictions based on varying event, tasks, human related conditions.

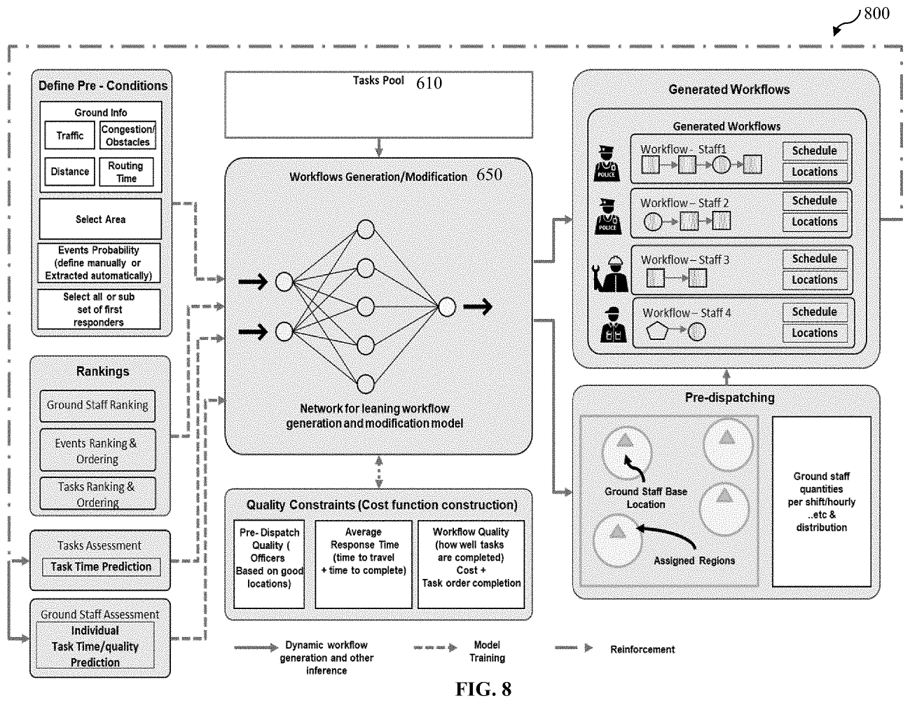

FIG. 8 depicts a schematic drawing illustrating an exemplary operation flow of the system 600, with respect to the WGM 650 of the GWE 620, according to various example embodiments. As shown in FIG. 8, the WGM 650 may be configured to utilize multiple data, information sources including ground information, rankings defined in the system, tasks predictions, ground staff assessment predictions to generate workflows. In addition to workflow generation, the WGM 650 may also result in deciding on geographical regions and individuals or group of ground staff from different types assigned to such regions in a given time period. Utilizing the same method, it may provide information on ground staff quantities required from different types to meet demands of a certain time period (such as in different working shifts). Such prediction on ground staff quantities required from different types at a certain time may be varying from time-to-time or working shift to working shift to meet different demands of events that is predicted based on historical events detected automatically from the event identification module 608 as described hereinbefore.

In various example embodiments, a main goal of the WGM 650 is the efficient utilization of plurality of ground staff members of different types that satisfies optimal conditions or constraints. Furthermore, the WGM 650 may be a model that learns (e.g., based on a machine learning model) based on various data, information, parameter or the like that can used to generate workflows, pre-dispatching regions or decide quantities of ground staff required from different types.

For example, when a plurality of events have occurred or recorded previously, it may be desired to allocate best suited personnel relevant to each event which may include a certain workflow to be followed to provide an appropriate response. Moreover, it is considered time to provide response which includes travelling time and time to perform a given task related to responding of a certain event. Thus, the system 600 may collect and store traffic information related to area of interest over time which may lead to predictions on road/road-segment wise traffic predictions for a certain time period of interest. The system 600 may leverage geographical information where it may determine the distance or the travelling time between points. In addition, the WGM 650 may read historical event locations, tasks completion history, tasks assessment (e.g., tasks time prediction) and ground staff assessment.

While taking inputs, the WGM 650 may learn a model (e.g., a machine learning model or mathematical model) recursively to optimize certain KPIs such as minimize response time, best and most suitable personnel to handle each event, maximize number of tasks completed, minimize amount of human resources required, minimize travelling time, minimize commodity resources or the like.

These KPIs optimization by the WGM 650 may defined as a minimization of certain cost or loss function by the WGM 650 while it is being trained recursively over time. Such loss or cost function may be defined based on one or more metrics such as average response time, dispatching quality, workflow quality or the like.

For example, when average response time is considered, the generated workflow may be configured to reduce travelling time for each individual or a group of individuals (or assets). The response time may further be calculated using traffic, distance and routing data (historical, current or predicted) with respect to geographical locations assigned in a certain workflow assignment. When the same cost/loss function is considered, the minimization of task execution time, by assuming a high skilled individual will conduct a certain task in a shorter period, overall workflow time may be reduced (travel time and task execution time) while assigning most suitable individual having considered travelling time/cost as well. Having defined such a kind of cost or loss function that reflect in KPIs satisfaction, the WGM 650 may improve to assign workflows automatically by considering multiple constraints. In this kind of situation, it may be considered to enforce response time and workflow quality at same time. In various other examples, it may also consider the total number of tasks covered per day as another constraint (as a cost/loss element to the WGM 650) whereby the WGM 650 will learn to assign workflows dynamically to cover a maximum number of tasks in a day or shift.

In another example, the WGM 650 may pre-assign working areas to each kind of individuals or each individual. In such situations, working shift or daily working regions, base location may be assigned to each individual by the WGM 650 in order to optimize a dispatch quality. For example, different kinds of events that can take place may be predicted based on the workflow execution log 622, event identification history, and so on, with associating other information such as traffic, weather and so on. In such cases, the individuals may be considered to be dispatched prior to events that may take place based on predicted locations. Thus, the WGM 650 may consider dispatch quality as an element of cost/loss function of the WGM 650 to predict working regions and quantities required for each shift and each regions, locations and so on. Mathematical calculation of dispatch quality may conducted by considering geographical distance difference between predicted event locations, densities and assigned region/location disparity.

The cost/loss function elements may include various kinds of matrices that represent quality, operational cost, time, KPI or the like related to event response.

At an initiation stage of the WGM 650, it may take more time to generate a model while considering multiple orientations of workflows automatically generated that minimizes cost or loss indicating metrics. However, as the system 600 runs through days, weeks or months, the WGM 650 may generate workflows in near-real-time while leveraging on previously learnt weights. In an inference stage, tasks in the tasks pool may be given as inputs and workflow generation and pre-dispatching results may be provided as output.

While each staff member is updating status of tasks assigned and it will be further reinforced in the WGM 650 to make predictions and workflow generation more optimized to satisfy KPIs.

In various example embodiments, during panic or highly critical situations, the system 600 may adjust the panic index automatically or either manually activated by operations center or ground staff In such cases, separate task ranking policy may apply where the generated workflows may be automatically modified. Modifications to workflows may be notified to mobile devices provided with each ground staff. Such modifications in critical situations may result in prioritization of certain tasks, events or events in a certain location or may also result in discarding certain tasks in individual workflows to ensure safety and security concerns. Further, such modifications may include delaying certain tasks due to critical situations. Automatic modifications to workflows may also take place in normal situations due to various configurations of systems, event and/or human conditions. For example, in situations where a certain staff cannot attend to a certain task due to health conditions, those tasks may be discarded from the unhealthy staff and may allocate to another ground staff or may allocate another staff member with new workflows. Nevertheless, such modifications may take place when demand in a certain location is increased more than expected to prevent additional cost encountered in transportation, travelling and so on. In another example, when a certain staff take more than predicated/usual time to complete a certain task, additional ground staff may be assigned to conduct the same task automatically or manually (via operations center or another ground staff). In another example, when there are obstacles such as traffic or congestions on road occurs, again the workflows may be modified as mentioned in previous scenarios. Such conditions where modifications may take place may further define or configure under workflow modification module.

The events conditions such as frequency or complexity may be varying over a certain period of time as a repeated pattern. For example, the different events may take place in different densities at different location between day time and night time. In such cases, event densities predictions along with task and resource skill/experience prediction models may be used to evaluate number of staff required from different kinds (fire, security, and so on) with their optimal locations for day time, night time, shift-wise, day-wise. Such prediction on number of staff required will lead minimization of human resources required and having a dynamic dispatching of ground staff in environment/space of interest (e.g., varying number of staff at varying locations). Furthermore, such dynamic dispatching may conduct based on certain constraints such as number of available staff, shift time, maximum number of working hours per week, maximum number of tasks that can be carried out (or certain kinds of tasks) in a day/week, and so on.

Workflows execution log may further utilize in auditing and reporting for investigations purposes or reviewing or communicating or alike operations. Workflows execution log may further be used in big data analytics to derive various situation analytics that will lead to improve situation awareness or will lead in certain configuration changes in workflow generation/modification.

Systems, methods and apparatus herein described are not only limited to efficient human resources utilization but also efficient assets utilizations. Such assets may include vehicles (police car, fire truck, delivery van, and so on) or equipment, machinery, and so on. In some examples, utilization will be done in hybrid manner where both human and assets may be assigned with automatically generated workflows in a combined manner. For example, certain vehicle and certain set of ground staff may generate a workflow identical based on asset/human capability, skill, performance, and so on. Workflows modifications may also be performed as described hereinbefore according to various embodiments.

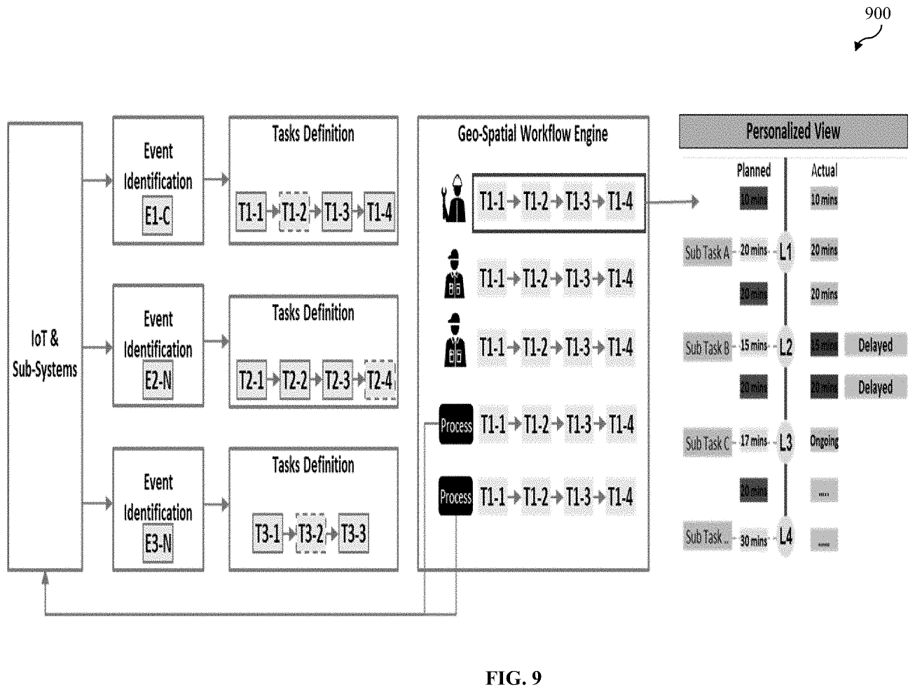

FIG. 9 depicts a high-level visualization of personalized view for a particular set of ground staff after personalized/individualized workflows have been assigned. As shown in FIG. 9, individual ground staff workflow assigned by WGM may be shown or notified and may consists of tasks/subtasks located in multiple locations, planned route and time estimations/predicted (to travel between tasks location and tasks completion). This may further be used in alerting operation center staff, supervisors or individual ground staff regarding progress, delays and so on based on either ground staff input, IoT sensor status, collected meta data such as real-time ground staff location.

The following examples pertain to further example embodiments of the present invention.

In Example 1, a method of workflow assignment using at least one processor is disclosed, the method comprising: identifying an actionable event; determining a plurality of tasks for the actionable event; determining, for each of the plurality of tasks, one or more task parameters related to the task; and generating, for the actionable event, a workflow for each of one or more individuals to perform at least one of the plurality of tasks based on the one or more task parameters.

In Example 2, the method according to Example 1 is disclosed, further comprising determining, for each of the plurality of tasks, one or more human resource parameters related to the task, wherein the above-mentioned generating the workflow is further based on the one or more human resource parameters.

In Example 3, the method according to Example 2, wherein the above-mentioned generating the workflow comprises optimizing the workflow for each of the one or more individuals based on the one or more task parameters, the one or more human resource parameters and one or more predetermined conditions.

In Example 4, the method according to Example 3 is disclosed, further comprising: determining a ranking of the plurality of tasks to obtain a tasks ranking; and determining, for each of the plurality of tasks, a ranking of a plurality of individuals with respect to the task to obtain an individuals ranking for the task.

In Example 5, the method according to Example 4 is disclosed, wherein the one or more human resource parameters include a current location and a current availability of the individual, and the above-mentioned ranking of the plurality of individuals with respect to the task is determined based on the current availability and the current location of each of the plurality of individuals.

In Example 6, the method according to Example 4 or 5 is disclosed, wherein the one or more human resource parameters further include a performance of each of the plurality of individuals with respect to the task, and the above-mentioned ranking of the plurality of individuals with respect to the task is determined further based on the performance of each of the plurality of individuals with respect to the task.

In Example 7, the method according to any one of Examples 4 to 6 is disclosed, wherein the one or more task parameters are selected from a group consisting of a location, a priority, a type, a frequency, a time, a cost and one or more required assets associated with the task, and the above-mentioned ranking of the plurality of tasks is determined based on the one or more task parameters associated with each of the plurality of tasks.

In Example 8, the method according to any one of Examples 4 to 7 is disclosed, further comprising determining an emergency rating for the plurality of tasks, wherein said ranking of the plurality of tasks is determined further based on the emergency rating.

In Example 9, the method according to Example 7 or 8 is disclosed, wherein the one or more task parameters further comprises an environment condition relating to the task.

In Example 10, the method according to any one of Examples 4 to 9 is disclosed, wherein the above-mentioned optimizing the workflow is further based on the individuals ranking and the tasks ranking.

In Example 11, the method according to any one of Examples 3 to 10 is disclosed, further comprising logging workflow executions to produce a workflow execution log database, wherein at least one of the one or more task parameters and the one or more human resource is determined based on the workflow execution log database.

In Example 12, the method according to Example 11 is disclosed, wherein the at least one of the one or more task parameters and the one or more human resource is determined using on a machine learning model based on the workflow execution log database.

In Example 13, a system for workflow assignment is disclosed, the system comprising: a memory; and at least one processor communicatively coupled to the memory and configured to perform the method of workflow assignment according to any one of Examples 1 to 12.

In Example 13, a computer program product, embodied in one or more non-transitory computer-readable storage mediums is disclosed, comprising instructions executable by at least one processor to perform the method of workflow assignment according to any one of Examples 1 to 12.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of workflow assignment using at least one processor, the method comprising:
identifying an actionable event;
determining a plurality of tasks for the actionable event;
determining, for each of the plurality of tasks, one or more task parameters related to the task; and
generating, for the actionable event, a workflow for each of one or more individuals to perform at least one of the plurality of tasks based on the one or more task parameters.

2. The method according to claim 1, further comprising determining, for each of the plurality of tasks, one or more human resource parameters related to the task, wherein said generating the workflow is further based on the one or more human resource parameters.

3. The method according to claim 2, wherein said generating the workflow comprises optimizing the workflow for each of the one or more individuals based on the one or more task parameters, the one or more human resource parameters and one or more predetermined conditions.

4. The method according to claim 3, further comprising:
determining a ranking of the plurality of tasks to obtain a tasks ranking; and
determining, for each of the plurality of tasks, a ranking of a plurality of individuals with respect to the task to obtain an individuals ranking for the task.

5. The method according to claim 4, wherein
the one or more human resource parameters include a current location and a current availability of the individual, and
said ranking of the plurality of individuals with respect to the task is determined based on the current availability and the current location of each of the plurality of individuals.

6. The method according to claim 4 or 5, wherein
the one or more human resource parameters further include a performance of each of the plurality of individuals with respect to the task, and
said ranking of the plurality of individuals with respect to the task is determined further based on the performance of each of the plurality of individuals with respect to the task.

7. The method according to claim 6, wherein
the one or more task parameters are selected from a group consisting of a location, a priority, a type, a frequency, a time, a cost and one or more required assets associated with the task, and
said ranking of the plurality of tasks is determined based on the one or more task parameters associated with each of the plurality of tasks.

8. The method according to claim 7, further comprising determining an emergency rating for the plurality of tasks, wherein said ranking of the plurality of tasks is determined further based on the emergency rating.

9. The method according to claim 8, wherein the one or more task parameters further comprises an environment condition relating to the task.

10. The method according to claim 9, wherein said optimizing the workflow is further based on the individuals ranking and the tasks ranking.

11. The method according to claim 10, further comprising logging workflow executions to produce a workflow execution log database, wherein at least one of the one or more task parameters and the one or more human resource is determined based on the workflow execution log database.

12. The method according to claim 11, wherein the at least one of the one or more task parameters and the one or more human resource is determined using on a machine learning model based on the workflow execution log database.

13. A system for workflow assignment, the system comprising:
a memory; and
at least one processor communicatively coupled to the memory and configured to:
identify an actionable event;
determine a plurality of tasks for the actionable event;
determine, for each of the plurality of tasks, one or more task related to the task; and
generate, for the actionable event, a workflow for each of one or more individuals to perform at least one of the plurality of tasks based on the one or more task parameters.

14. The system according to claim 13, wherein the at least one processor is further configured to determine, for each of the plurality of tasks, one or more human resource parameters related to the task, and said generate the workflow is further based on the one or more human resource parameters.

15. The system according to claim 14, wherein said generate the workflow comprises optimizing the workflow for each of the one or more individuals based on the one or more task parameters, the one or more human resource parameters and one or more predetermined conditions.

16. The system according to claim 15, wherein the at least one processor is further configured to:
determine a ranking of the plurality of tasks to obtain a tasks ranking; and
determine, for each of the plurality of tasks, a ranking of a plurality of individuals with respect to the task to obtain an individuals ranking for the task.

17. The system according to claim 16, wherein
the one or more human resource parameters include a current location and a current availability of the individual, and
said ranking of the plurality of individuals with respect to the task is determined based on the current availability and the current location of each of the plurality of individuals.

18. The system according to claim 17, wherein
the one or more human resource parameters further include a performance of each of the plurality of individuals with respect to the task, and
said ranking of the plurality of individuals with respect to the task is determined further based on the performance of each of the plurality of individuals with respect to the task.

19. The system according to claim 18, wherein
the one or more task parameters are selected from a group consisting of a location, a priority, a type, a frequency, a time, a cost and one or more required assets associated with the task, and
said ranking of the plurality of tasks is determined based on the one or more task parameters associated with each of the plurality of tasks.

20. The system according to claim 19, further comprising determining an emergency rating for the plurality of tasks, wherein said ranking of the plurality of tasks is determined further based on the emergency rating.

21. The system according to claim 20, wherein the one or more task parameters further comprises an environment condition relating to the task.

22. The system according to claim 21, wherein said optimizing the workflow is further based on the individuals ranking and the tasks ranking.

23. The system according to claim 22, further comprising logging workflow executions to produce a workflow execution log database, wherein at least one of the one or more task parameters and the one or more human resource is determined based on the workflow execution log database.

24. The system according to claim 23, wherein the at least one of the one or more task parameters and the one or more human resource is determined using on a machine learning model based on the workflow execution log database.

25. A computer program product, embodied in one or more non-transitory computer-readable storage mediums, comprising instructions executable by at least one processor to perform a method of workflow assignment comprising:
identifying an actionable event;
determining a plurality of tasks for the actionable event;
determining, for each of the plurality of tasks, one or more task parameters related to the task; and
generating, for the actionable event, a workflow for each of one or more individuals to perform at least one of the plurality of tasks based on the one or more task parameters.
